(19) United States
(12) Patent Application Publication
(10) Pub. No.: US 2025/0286128 A1
(43) Pub. Date: Sep. 11, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Aeran KIM, Yongin-si (KR); Myunghoon KIM, Yongin-si (KR); Seungryong OH, Yongin-si (KR); Dahyun KIM, Yongin-si (KR); Jeongmin SHIN, Yongin-si (KR); SANGHOON KIM, Yongin-si (KR)

(21) Appl. No.: 18/802,962

(22) Filed: Aug. 13, 2024

(30) Foreign Application Priority Data
Mar. 8, 2024 (KR) 10-2024-0033271

(51) Int. Cl. H01M 10/0567; H01M 4/02; H01M 4/38; H01M 4/583; H01M 10/052

(52) U.S. Cl. CPC H01M 10/0567; H01M 4/386; H01M 4/583; H01M 10/052; H01M 2004/027

(57) ABSTRACT

Disclosed are electrolytes and rechargeable lithium batteries including the same. The electrolyte includes a non-aqueous organic solvent, a lithium salt, and an additive. The additive includes a first compound represented by Chemical Formula 1 and a second compound represented by Chemical Formula 2. A detailed description of Chemical Formulae 1 and 2 is given in this description.

### CROSS-REFERENCE TO RELATED APPLICATION

The present application claims priority to and the benefit of Korean Patent Application No. 10-2024-0033271, filed on Mar. 8, 2024, in the Korean Intellectual Property Office, the entire content of which is hereby incorporated by reference.

### BACKGROUND

### 1. Field

Embodiments of the present disclosure relate to an electrolyte for a rechargeable lithium battery and a rechargeable lithium battery including the same.

### 2. Description of the Related Art

Recently, with the rapid spread of battery using electronic devices, such as mobile phones, laptop computers, and electric vehicles, there is a rapidly increasing interest in rechargeable batteries having high energy density and high capacity. Therefore, intensive research has been conducted to improve performance of rechargeable lithium batteries.

A rechargeable lithium battery includes a positive electrode, a negative electrode, and an electrolyte, which positive and negative electrodes include a respective active material in which intercalation and deintercalation are possible, and generates electrical energy caused by oxidation and reduction reactions if lithium ions are intercalated and deintercalated.

A lithium salt dissolved in a non-aqueous organic solvent is used as the electrolyte of the rechargeable lithium battery. Characteristics of the rechargeable lithium battery are exhibited by complex reactions between the positive electrode and the electrolyte and between the negative electrode and the electrolyte. Accordingly, the use of a suitable or appropriate electrolyte is an important variable for improvement of the rechargeable lithium battery.

### SUMMARY

An embodiment of the present disclosure provides an electrolyte for a rechargeable lithium battery having improved high-temperature lifetime and high-temperature stability characteristics.

An embodiment of the present disclosure provides a rechargeable lithium battery including the electrolyte.

According to an embodiment of the present disclosure, an electrolyte for a rechargeable lithium battery may include: a non-aqueous organic solvent; a lithium salt; and an additive.

The additive may include a first compound represented by Chemical Formula 1 and a second compound represented by Chemical Formula 2.

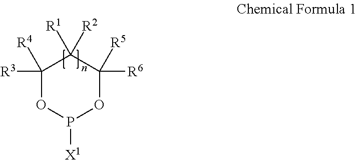

In Chemical Formula 1,
X¹ may be a fluoro group, a chloro group, a bromo group, or an iodo group.
R¹ to R⁶ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.
n may be an integer of 0 or 1.

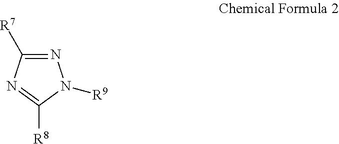

In Chemical Formula 2,
R⁷ to R⁹ may each independently be hydrogen, halogen, a substituted or unsubstituted C1 to C10 alkyl group, or a substituted or unsubstituted C3 to C10 cycloalkyl group.

According to an embodiment of the present disclosure, a rechargeable lithium battery may include: a positive electrode that includes a positive electrode active material; a negative electrode that includes a negative electrode active material; and the electrolyte for the rechargeable lithium battery.

### BRIEF DESCRIPTION OF DRAWINGS

The accompanying drawings, together with the specification, illustrate embodiments of the subject matter of the present disclosure, and, together with the description, serve to explain principles of embodiments of the subject matter of the present disclosure.

FIG. 1 illustrates a simplified conceptual diagram showing a rechargeable lithium battery according to an embodiment of the present invention.

FIGS. 2-5 are views illustrating simplified diagrams showing rechargeable lithium batteries according to embodiments, in which FIG. 2 shows a cylindrical battery,

FIG. 3 shows a prismatic battery, and FIGS. 4-5 show pouch-type batteries.

### DETAILED DESCRIPTION OF EMBODIMENTS

In order to sufficiently understand examples of the configuration and effect of the subject matter of the present disclosure, some embodiments of the present disclosure will be described with reference to the accompanying drawings. It should be noted, however, that the present disclosure is not limited to the following example embodiments, and may be implemented in various suitable forms. Rather, the example embodiments are provided only to disclose the subject matter of the present disclosure and let those skilled in the art fully know the scope of the present disclosure.

In this description, it will be understood that, if an element is referred to as being on another element, the element can be directly on the other element or intervening elements may be present between therebetween. In the drawings, thicknesses of some components may be exaggerated to effectively explain the technical contents of the present disclosure. Like reference numerals refer to like elements throughout the specification.

Unless otherwise specially noted in this description, the expression of a singular form may include the expression of a plural form. In embodiments, unless otherwise specially noted, the phrase “A or B” may indicate “A but not B”, “B but not A”, or “A and B”. The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, and/or a reaction product.

Unless otherwise especially defined in this description, a particle diameter may be an average particle diameter. In embodiments, a particle diameter indicates an average particle diameter (D50) where a cumulative volume is about 50 volume % in a particle size distribution. The average particle diameter (D50) may be measured by any suitable method generally used in the art, for example, by a particle size analyzer, a transmission electron microscope (TEM) image, and/or a scanning electron microscope (SEM) image. In embodiments, a dynamic light-scattering measurement device is used to perform a data analysis, the number of particles is counted for each particle size range, and then from this, an average particle diameter (D50) value may be obtained through a calculation. In embodiments, a laser scattering method may be utilized to measure the average particle diameter (D50). In the laser scattering method, a target particle is distributed in a distribution solvent, introduced into a laser scattering particle measurement device (e.g., MT3000 commercially available from Microtrac, Inc), irradiated with ultrasonic waves of 28 kHz at a power of 60 W, and then an average particle diameter (D50) is calculated in the 50% standard of particle diameter distribution in the measurement device.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a combination thereof.

In more detail, the term “substituted” may indicate that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may indicate that at least one hydrogen of a substituent or a compound is substituted by deuterium, a halogen group, a C1 to C20 alkyl group, a C6 to C30 aryl group, a C1 to C10 fluoroalkyl group, or a cyano group. In embodiments, the term “substituted” may indicate that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may indicate that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

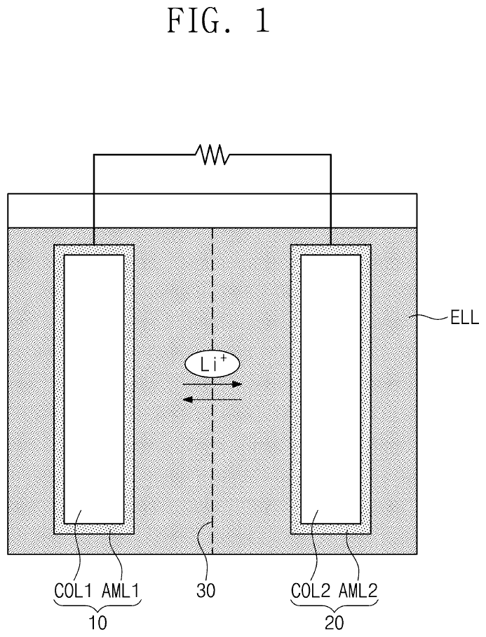

FIG. 1 illustrates a simplified conceptual diagram showing a rechargeable lithium battery according to an embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated with the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 or the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and further include a binder and/or a conductive material (e.g., an electrically conductive material).

For example, the positive electrode 10 may further include an additive that can serve as a sacrificial positive electrode.

An amount of the positive electrode active material may range from about 90 wt % to about 99.5 wt % based on 100 wt % of the positive electrode active material layer AML1. Amounts of the binder and the conductive material may be about 0.5 wt % to about 5 wt % based on 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and/or nylon, but the present disclosure is not limited thereto.

The conductive material may be used to provide an electrode with conductivity (e.g., electrical conductivity), and any suitable electrically conductive material that does not cause a chemical change of a battery (e.g., an undesirable chemical change in the rechargeable lithium battery) may be used as the conductive material to constitute the battery. The conductive material may include, for example, a carbon-based material such as natural graphite, artificial graphite, carbon black, acetylene black, Ketjenblack, carbon fiber, carbon nano-fiber, and carbon nano-tube; a metal powder and/or metal fiber containing one or more selected from copper, nickel, aluminum, and silver; a conductive polymer (e.g., an electrically conductive polymer) such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., a lithiated intercalation compound) that can reversibly intercalate and deintercalate lithium. For example, the positive electrode active material may include at least one kind of composite oxide including lithium and metal that is selected from cobalt, manganese, nickel, and a combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound represented by one of chemical formulae below. LiₐA_{1-b}X_{b}O_{2-c}D_{c} (0.90≤a≤1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}Co_{b}X_{c}O_{2-α}D_{α} (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0≤c≤0.5, 0<α<2), LiₐNi_{b}Co_{c}L¹_{d}GeO₂ (0.90≤a≤1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}G_{b}O₂ (0.90≤a≤1.8, 0.001≤b≤0.1), LiₐMn₂G_{b}O₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and LiₐFePO₄ (0.90≤a≤1.8).

In the chemical formulae above, A is Ni, Co, Mn, or a combination thereof, X is Al, Ni, Co, Mn, Cr, Fe, Mg, Sr, V, a rare-earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

For example, the positive electrode active material may be a high nickel-based positive electrode active material having a nickel content of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % based on 100 mol % of metal devoid of lithium (e.g., based on 100 mol % of metal other than lithium) in the lithium transition metal composite oxide. The high nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive material (e.g., an electrically conductive material).

For example, the negative electrode active material layer AML2 may include a negative electrode active material of about 90 wt % to about 99 wt %, a binder of about 0.5 wt % to about 5 wt %, and a conductive material (e.g., an electrically conductive material) of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

If an aqueous binder is used as the negative electrode binder, a cellulose-based compound capable of providing or increasing viscosity may further be included. The cellulose-based compound may include one or more selected from carboxymethyl cellulose, hydroxypropylmethyl cellulose, methyl cellulose, and alkali metal salts thereof. The alkali metal may include Na, K, and/or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material may be used to provide an electrode with conductivity (e.g., electrical conductivity), and any suitable electrically conductive material that does not cause chemical change of a battery (e.g., an undesirable chemical change in the rechargeable lithium battery) may be used as the conductive material to constitute the battery. For example, the conductive material may include a carbon-based material such as natural graphite, artificial graphite, carbon black, acetylene black, Ketjenblack, carbon fiber, carbon nano-fiber, and carbon nano-tube; a metal powder and/or metal fiber including one or more selected from copper, nickel, aluminum, and silver; a conductive polymer (e.g., an electrically conductive polymer) such as a polyphenylene derivative; or a mixture thereof.

The current collector COL2 may include a copper foil, a nickel foil, a stainless-steel foil, a titanium foil, a nickel foam, a copper foam, a polymer substrate coated with a conductive metal (e.g., an electrically conductive metal), or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, and/or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, and/or fiber-shaped natural and/or artificial graphite, and the amorphous carbon may include soft carbon, hard carbon, mesophase pitch carbon, and/or calcined coke.

The lithium metal alloy may include an alloy of lithium and metal that is selected from Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material and/or a Sn-based negative electrode active material. The Si-based negative electrode active material may include silicon, silicon-carbon composite, SiOx (0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) on a surface of the secondary particle. The amorphous carbon may also be between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles and may also include an amorphous carbon coating layer on a surface of the core.

The Si-based negative electrode active material and/or the Sn-based negative electrode active material may be used in combination with a carbon-based negative electrode active material.

In an embodiment, the negative electrode active material may include a carbon-based negative electrode active material and/or a silicon-based negative electrode active material. The negative electrode active material may further include carbon (C) and silicon (Si). For example, the carbon-based negative active material may be graphite, and the silicon-based negative electrode active material may be silicon nano-particles.

A weight ratio of the silicon nano-particles to the graphite may range from about 0.1 to about 20 or about 1 to about 10. If the weight ratio of the silicon nano-particles to the graphite is included within the ranges above, it may be possible to increase a buffering effect against volume expansion of the silicon nano-particles, to achieve excellent electrical conductivity, and to improve lifetime characteristics.

The silicon nano-particle may be a nano-sized silicon particle. The silicon nano-particles may have an average particle diameter range from about 50 to 300 nm, for example, from about 80 to 200 nm. If a silicon particle has a nano-size, smooth intercalation/deintercalation of lithium ions and low ion resistance may be achieved to suppress or reduce volume expansion and to improve lifetime characteristics.

### Separator 30

Based on a type (or kind) of the rechargeable lithium battery, the separator 30 may be between positive electrode 10 and the negative electrode 20. The separator 30 may include one or more selected from polyethylene, polypropylene, and polyvinylidene fluoride, and may have a multi-layered separator thereof such as a polyethylene/polypropylene bi-layered separator, a polyethylene/polypropylene/polyethylene tri-layered separator, and/or a polypropylene/polyethylene/polypropylene tri-layered separator.

The separator 30 may include a porous substrate and a coating layer on one or opposite (e.g., two opposing) surfaces of the porous substrate, which coating layer includes an organic material, an inorganic material, or a combination thereof.

The porous substrate may be a polymer layer including one selected from polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, and/or may be a copolymer and/or mixture including two or more of the materials mentioned above.

The organic material may include a polyvinylidenefluoride-based copolymer and/or a (meth)acrylic copolymer.

The inorganic material may include an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed together in one coating layer or may be a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may serve as a medium that transmits ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, caprolactone, and/or propyl propionate (PP).

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The aprotic solvent may include nitriles such as R—CN (where R is a hydrocarbon group having a C2 to C20 linear, branched, or cyclic structure and may include a double bond, an aromatic ring, and/or an ether group); amides such as dimethylformamide; dioxolanes such as 1,3-dioxolane and/or 1,4-dioxolane; and/or sulfolanes.

The non-aqueous organic solvent may be used alone or in a mixture of two or more substances.

In embodiments, if a carbonate-based solvent is used, a cyclic carbonate and a chain carbonate may be mixed together and used, and the cyclic carbonate and the chain carbonate may be mixed together in a volume ratio of about 1:1 to about 1:9.

The lithium salt may be a material that is dissolved in the non-aqueous organic solvent to serve as a supply source of lithium ions in a battery and plays a role in enabling a basic operation of the rechargeable lithium battery and in promoting the movement of lithium ions between positive and negative electrodes. The lithium salt may include, for example, at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium difluoro(oxalato)borate(LiDFOB), lithium difluorobis(oxalato)phosphate (LiDFBOP), and lithium bis(oxalato) borate (LiBOB)

The following will describe in more detail an electrolyte of a rechargeable lithium battery according to some embodiments of the present disclosure.

An electrolyte for a rechargeable lithium battery according to an embodiment may include a non-aqueous organic solvent, a lithium salt, and an additive.

The additive may include a first compound represented by Chemical Formula 1 below and a second compound represented by Chemical Formula 2 below.

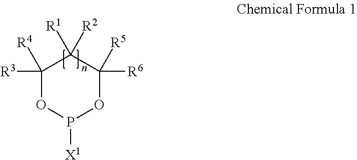

In Chemical Formula 1,
X¹ may be a fluoro group, a chloro group, a bromo group, or an iodo group.
R¹ to R⁶ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.

In embodiments, n may be an integer of 0 or 1.

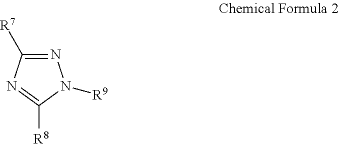

In Chemical Formula 2,
R⁷ to R⁹ may each independently be hydrogen, halogen, a substituted or unsubstituted C1 to C10 alkyl group, or a substituted or unsubstituted C3 to C10 cycloalkyl group.

The electrolyte may be prepared by a mixing process in which the lithium salt is dissolved in the non-aqueous organic solvent, and the first compound and the second compound are added to the resultant mixture. The electrolyte mixing process be any suitable one generally used in the electrolyte fabrication field, and a person skilled in the art should be able to appropriately select and use an electrolyte mixing process upon reviewing this disclosure.

The non-aqueous organic solvent may include at least one selected from ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

In an embodiment, the non-aqueous organic solvent may be a mixed solvent of ethylene carbonate (EC), ethylmethyl carbonate (EMC), and dimethyl carbonate (DMC).

For example, the ethylene carbonate (EC) may be included in an amount of about 10 vol % to about 30 vol % relative to the total volume of the non-aqueous organic solvent. The ethylmethyl carbonate (EMC) solvent may be included in an amount of about 5 vol % to about 15 vol % relative to the total volume of the non-aqueous organic solvent. The dimethyl carbonate (DMC) solvent may be included in an amount of about 50 vol % to about 80 vol % relative to the total volume of the non-aqueous organic solvent.

In an embodiment, the lithium salt may include LiPF₆.

The lithium salt may have a concentration of about 0.1 M to about 2.0 M. For example, the lithium salt may have a concentration of equal to or greater than about 0.5 M or equal to or greater than 1.0 M. The lithium salt may have a concentration of equal to or less than about 2.0 M, equal to or less than about 1.7 M, or equal to or less than about 1.5 M. In the present disclosure, if the lithium salt has a concentration of about 0.1 M to about 2.0 M, the electrolyte may suitably or appropriately maintain its conductivity (e.g., ionic or electrical conductivity) and viscosity.

### First Compound

The first compound according to an embodiment of the present disclosure may be represented by Chemical Formula 1 below.

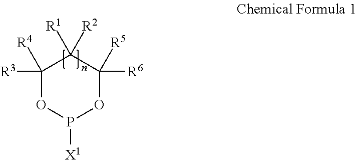

In Chemical Formula 1,
X¹ may be a fluoro group, a chloro group, a bromo group, or an iodo group.
R¹ to R⁶ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.

In embodiments, n may be an integer of 0 or 1.

The first compound may form, on a surface of the negative electrode, a solid electrolyte interface (SEI) layer having high-temperature stability and excellent ion conductivity. In embodiments, the first compound may reduce gas generation caused by a decomposition reaction that occurs in the electrolyte during high-temperature storage. For example, a —PO₂F functional group of the first compound may stabilize a pyrolyzed product of the lithium salt such as LiPF₆ and/or ions dissociated from the lithium salt to reduce the generation of gas such as HF. The formation of the excellent SEI layer and the reduction of gas generation may contribute to an improvement in lifetime characteristics of and a reduction of internal resistance of the rechargeable lithium battery.

The improvement in lifetime characteristics of and the reduction in internal resistance of the rechargeable lithium battery at high temperatures caused by the first compound may become pronounced if the first compound is used together with a high nickel-based positive electrode active material and a negative electrode active material including graphite and silicon particles. For example, silicon particles may be utilized to increase battery capacity, but there may be a problem of an increase in battery internal resistance (e.g., battery internal electrical resistance) due to a side reaction between the silicon particles and the electrolyte. If the first compound is introduced as the additive, the side reaction between the silicon particles and the electrolyte may be suppressed or reduced not only to minimize or reduce an increase in battery internal resistance (e.g., battery internal electrical resistance), but also to maximize or increase battery capacity.

The first compound may include a cyclic phospholane derivative. Compared to a linear phosphite derivative, the cyclic phospholane derivative may cause the rechargeable lithium battery to have a significant improvement in lifetime characteristics. It may be because that the linear phosphite derivative induces a side reaction of LiPF₆ due to a dissociated —PO₂F functional group and causes gas generation due to a decomposition reaction of the electrolyte during high-temperature storage.

In an embodiment, Chemical Formula 1 may be represented by Chemical Formula 1A below or Chemical Formula 1B below.

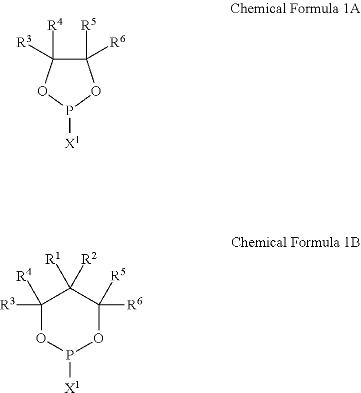

In Chemical Formula 1A and Chemical Formula 1B,
X¹ may be a fluoro group, a chloro group, a bromo group, or an iodo group.
R¹ to R⁶ may each independently be hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In an embodiment, R³ and R⁴ of Chemical Formula 1A may each be hydrogen.

At least one selected from R⁵ and R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In an embodiment, the first compound may be one selected from compounds listed in Group 1 below. For example, the first compound may be at least one selected from 2-fluoro-1,3,2-dioxaphospholane and 2-fluoro-4-methyl-1,3,2-dioxaphospholane.

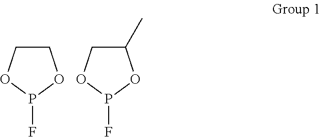

The first compound may have an amount of about 0.2 parts by weight to about 5.0 parts by weight based on 100 parts by weight of the electrolyte for the rechargeable lithium battery. For example, the first compound may have an amount of about 0.5 parts by weight to about 1.5 parts by weight based on 100 parts by weight of the electrolyte for the rechargeable lithium battery. The amount of the first compound may refer to a weight of the first compound included in the electrolyte based on the total weight of the electrolyte. If the amount of the first compound satisfies the ranges above, it may be possible to maximize or increase the effect of reduction in gas generation and the effect of formation of the excellent SEI layer at high temperatures.

### Second Compound

The second compound according to an embodiment of the present disclosure may be represented by Chemical Formula 2 below.

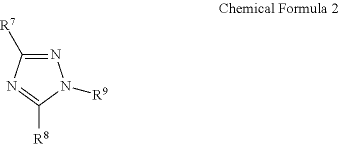

In Chemical Formula 2,
R⁷ to R⁹ may each independently be hydrogen, halogen, a substituted or unsubstituted C1 to C10 alkyl group, or a substituted or unsubstituted C3 to C10 cycloalkyl group.

The second compound may have effects of reducing gas generation and suppressing or reducing dissolution of transition metal included in the positive electrode. Thus, the rechargeable lithium battery may improve in lifetime characteristics and decrease in internal resistance. For example, a triazole group of the second compound may form a film on a surface of the positive electrode by coordinately bonding with metals contained in the positive electrode active material, thereby reducing gas generation due to a side reaction between a positive electrode interface and the electrolyte and suppressing or reducing degradation of the positive electrode surface. These effects may become pronounced at high temperatures.

The second compound may include 1,2,4-triazole. Compared to 1,2,3-triazole, 1,2,4-triazole may significantly improve high-temperature characteristics of the rechargeable lithium battery. For example, 1,2,4-triazole may become more effective if being used together with a high nickel-based positive electrode active material. If 1,2,3-triazole forms a film on the positive electrode surface by coordinately bonding with metals contained in the positive electrode active material, and a steric arrangement with nickel may be less effective compared to 1,2,4-triazole.

In an embodiment, the second compound may be represented by Chemical Formula 2A.

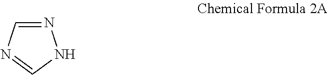

The second compound may be included in an amount of about 1 part by weight to about 5 parts by weight based on 100 parts by weight of the electrolyte for the rechargeable lithium battery. The amount of the second compound may refer to a weight of the second compound included in the electrolyte based on the total weight of the electrolyte. If the amount of the second compound satisfies the range above, a suppression or reduction in degradation of positive electrode surface and a reduction in gas generation at high temperatures may be maximized or increased to maximize or increase an improvement in lifetime characteristics and a reduction in internal resistance (e.g., internal electrical resistance) of the rechargeable lithium battery.

### Additive

An electrolyte for a rechargeable lithium battery according to the present disclosure may include a non-aqueous organic solvent, a lithium salt, and an additive. The additive may include the first compound and the second compound.

If the second compound is used in combination with a fluorinated lithium salt compound (e.g., the first compound), a synergistic effect may be produced. The combination of the first and second compounds may lead to a suppression or reduction in gas generation, an improvement in capacity retention rate, and an enhancement in lifetime characteristics of lithium batteries. For example, the effect of the first compound in forming the excellent SEI layer and reducing gas generation and the effect of the second compound in suppressing or reducing dissolution of transition metals of the positive electrode and reducing gas generation may be produced concurrently to maximize or increase an improvement in characteristics of lithium batteries. This synergistic effect may become more pronounced at high temperatures.

The additive may be included in an amount of about 1.2 to 10 parts by weight based on 100 parts by weight of the electrolyte for the rechargeable lithium battery. The amount of the additive may refer to a weight of the additive included in the electrolyte based on the total weight of the electrolyte. If the amount of the additive satisfies the range above, the rechargeable lithium battery may be maximized or improved in a suppression or reduction in gas generation, an increase in capacity retention rate, and an enhancement in lifetime characteristics. This improvement in battery characteristics may become more pronounced at high temperatures.

A weight ratio of the second compound to the first compound in the electrolyte may range from about 0.2 to about 25. For example, the weight ratio of the second compound to the first compound in the electrolyte may range from about 1 to about 5. An improvement in high-temperature characteristics of the rechargeable lithium battery may become maximized or improved in the weight ratio ranges mentioned above. If the weight ratio of the second compound to the first compound is less than the ranges above, Coulombic effect may be abruptly decreased, and if the weight ratio of the second compound to the first compound is greater than the ranges above, a film may not be suitably or sufficiently formed on a surface of the positive electrode.

### Rechargeable Lithium Battery

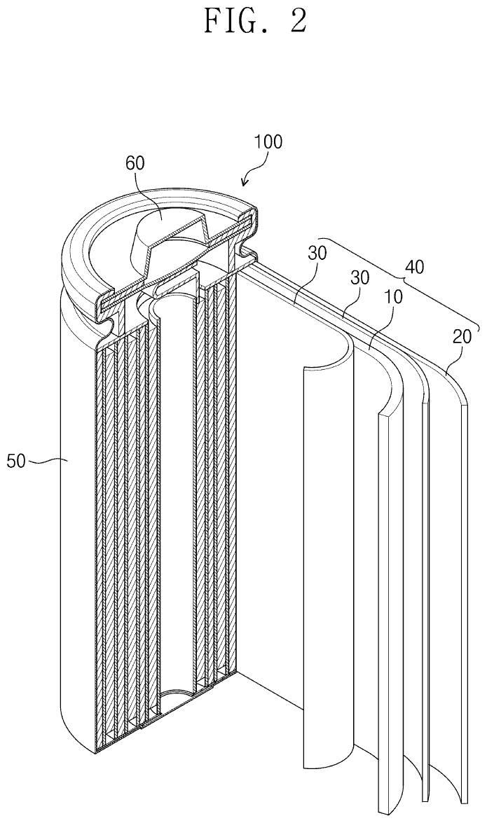

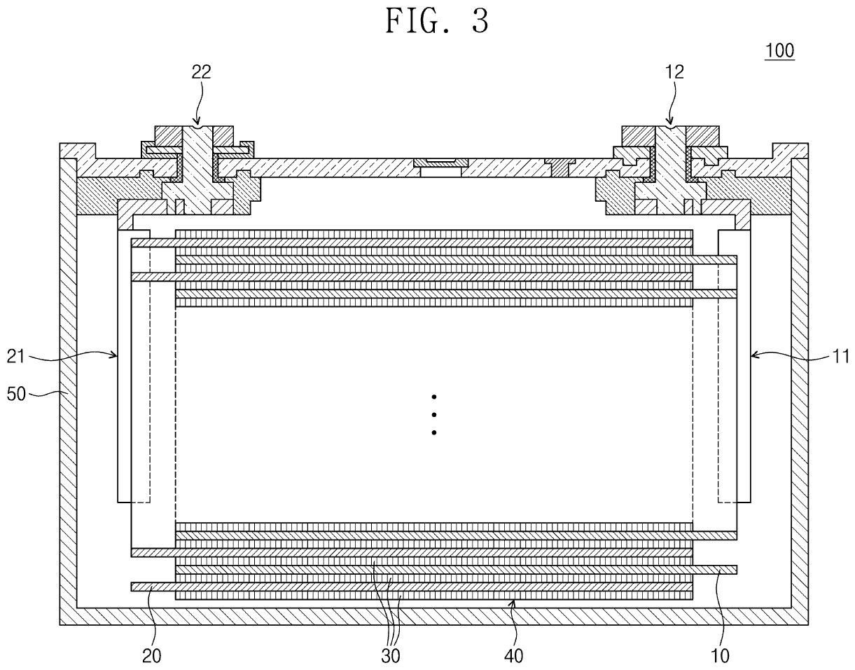

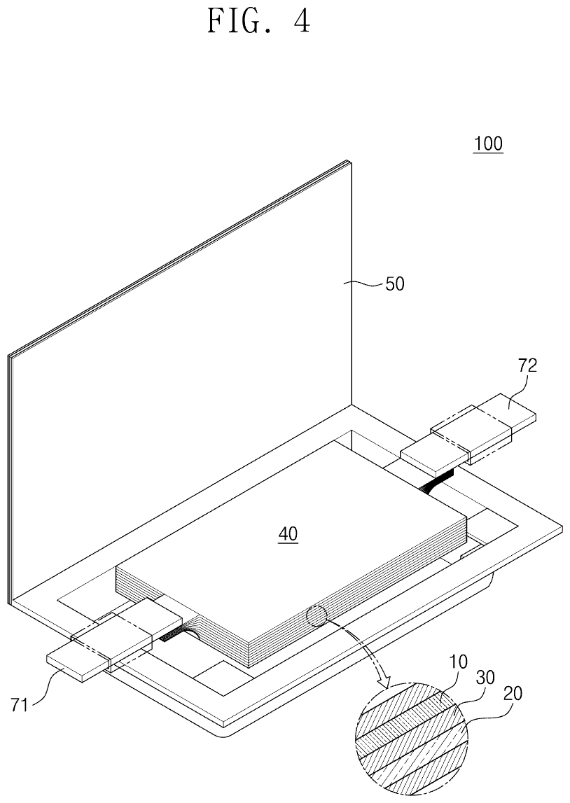

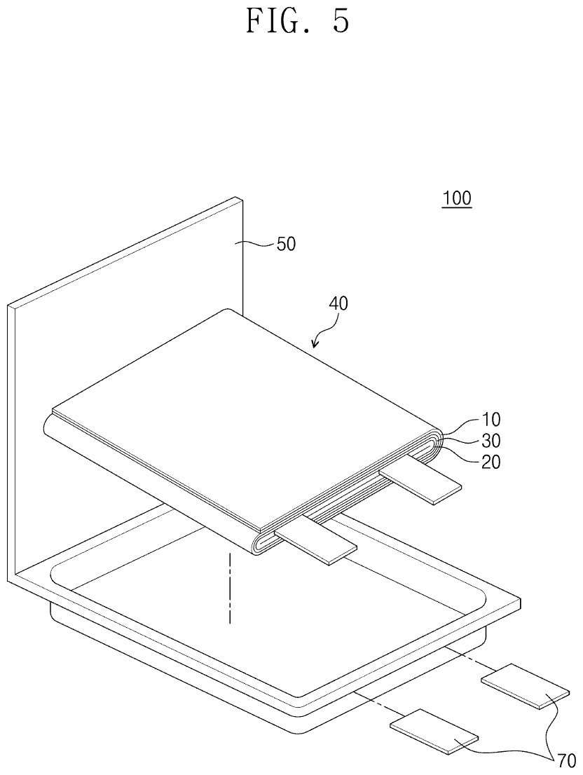

Based on shape of a rechargeable lithium battery, the rechargeable lithium battery may be classified into cylindrical, prismatic, pouch, and/or coin types (or kinds). In FIGS. 2-5 illustrating simplified diagrams showing a rechargeable lithium battery according to an embodiment, FIG. 2 shows a cylindrical battery, FIG. 3 shows a prismatic battery, and FIGS. 4-5 show pouch-type batteries. Referring to FIGS. 2-4, a rechargeable lithium battery 100 may include an electrode assembly 40 in which a separator 30 is between a positive electrode 10 and a negative electrode 20, and may also include a casing 50 in which the electrode assembly 40 is accommodated. The positive electrode 10, the negative electrode 20, and the separator 30 may be impregnated with an electrolyte. The rechargeable lithium battery 100 may include a sealing member 60 that seals the casing 50 as illustrated in FIG. 2. In embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4-5, the rechargeable lithium battery 100 may include an electrode tab 70 (FIG. 5), or a positive electrode tab 71 and a negative electrode tab 72 (FIG. 4), which electrode tab 70 serves as an electrical path that externally induces a current generated in the electrode assembly 40.

A rechargeable lithium battery according to an embodiment of the present disclosure may be applied to automotive vehicles, mobile phones, and/or any other suitable electrical devices, but the present disclosure is not limited thereto.

A rechargeable lithium battery according to embodiments of the present disclosure may include a positive electrode including a positive electrode active material, a negative electrode including a negative electrode active material, and the aforementioned electrolyte for the rechargeable lithium battery.

The positive electrode active material may include lithium composite oxide represented by Chemical Formula 3 below.

LiₓM¹_{y}M²_{z}M³_{1-y-z}O₂₋ₐXₐ Chemical Formula 3

In Chemical Formula 3, x, y, z, and a may be such that 0.5≤x≤1.8, 0≤a≤0.05, 0<y≤1, 0≤z≤, and 0≤y+z≤1.
M¹, M², and M³ may each independently include at least one element selected from metals such as Ni, Co, Mn, Al, B, Ba, Ca, Ce, Cr, Fe, Mo, Nb, Si, Sr, Mg, Ti, V, W, Zr, La, and a combination thereof.
X may include at least one element selected from F, S, P, and Cl.

In an embodiment, in Chemical Formula 3, M¹ may be Ni, y may be 0.8≤y≤1, and z may be 0≤z≤0.2. In embodiments, in Chemical Formula 3, M¹ may be Ni, M² may be Co, and M³ may be Al. In embodiments, in Chemical Formula 3, M¹ may be Ni, M² may be Co, and M³ may be Mn.

The negative electrode active material may be a carbon-based negative electrode active material, a Si-based negative electrode active material, a Sn-based negative electrode active material, or a combination thereof.

In an embodiment, the negative electrode active material may include a carbon-based negative electrode active material and/or a Si-based negative electrode active material. For example, the carbon-based negative active material may be graphite, and the Si-based negative electrode active material may be a silicon nano-particle. A weight ratio of the silicon nano-particles to the graphite may range from about 0.1 to about 20. If the graphite and the silicon nano-particles satisfy the combination and weight ratio above, the rechargeable lithium battery may have a maximum or increased improvement in high-temperature performance.

In a rechargeable lithium battery according to an embodiment of the present disclosure, a non-aqueous electrolyte may be decomposed during an initial charge-discharge to form a film having passivation ability on surfaces of positive and negative electrodes to improve high-temperature storage characteristics. The film may be deteriorated due to acid such as HF⁻ and PF₅⁻ produced by thermal decomposition of lithium salts (LiPF₆ and/or the like) widely used in lithium-ion batteries. This acid attack may elute transition metal elements from the positive electrode and increase a surface resistance (e.g., a surface electrical resistance) of the electrode caused by a structural change of the surface. Thus, a theoretical capacity may be reduced due to loss of metal elements which are redox (reduction and oxidation) centers, which may result in a reduction in capacity. The eluted transition metal ions may be electrodeposited on the negative electrode that reacts in a strong reduction potential range. Therefore, electrons may be consumed and the film may be destroyed during the electrodeposition, and accordingly the surface of the negative electrode may be exposed to cause an additional electrolyte decomposition reaction. There may thus be an increase in resistance (e.g., electrical resistance) of the negative electrode and in irreversible capacity, and as a result, there may be a problem of continuous reduction in cell capacity.

In the present disclosure, a triazole group of the second compound represented by Chemical Formula 2 above may provide an unshared electron pair to capture PF₅⁻ and stabilize a LiPF₆ salt, with the result that it may be possible to remove the acid led by decomposition of the lithium salt.

The positive electrode active material of the rechargeable lithium battery may include one or more selected from lithium-cobalt-based oxide, lithium nickel-based oxide, lithium manganese-based oxide, lithium iron phosphate-based compounds, cobalt-free nickel-manganese-based oxide, and any combination thereof. In an embodiment, the positive electrode active material of the rechargeable lithium battery may include nickel, cobalt, and aluminum. In an embodiment, the positive electrode active material of the rechargeable lithium battery may include nickel, cobalt, and manganese.

The negative electrode active material of the rechargeable lithium battery may include a carbon-based negative electrode active material, a silicon-based negative electrode active material, or any combination thereof. In an embodiment, the negative electrode active material of the rechargeable lithium battery may include a carbon-based negative electrode active material and a silicon-based negative electrode active material. For example, the carbon-based negative active material may be graphite, and the silicon-based negative electrode active material may be a silicon nano-particle. A weight ratio of the silicon nano-particles to the graphite may range from about 0.1 to about 20.

The following will describe Examples and Comparative Examples of the present disclosure. The following Examples are only example embodiments of the present disclosure, and the present disclosure is not limited to the following examples.

### Example 1

### (1) Preparation of Electrolyte

1.5 M LiPF₆ was dissolved in a non-aqueous organic solvent in which ethylene carbonate (EC), ethylmethyl carbonate (EMC), and dimethyl carbonate (DMC) were mixed together in a volume ratio of about 20:10:70, and an additive was added to prepare an electrolyte.

The additive included a first compound in an amount of 1 part by weight based on 100 parts by weight of the electrolyte and a second compound in an amount of 1 part by weight based on 100 parts by weight of the electrolyte.

A material represented by Chemical Formula 1C below and a material represented by Chemical Formula 2A below were respectively used as the first compound and the second compound.

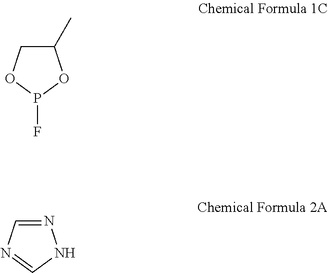

### (2) Fabrication of Rechargeable Lithium Battery

LiNi_{0.91}Co_{0.07}Al_{0.02}O₂ as a positive electrode active material, polyvinylidene fluoride as a binder, and Ketjenblack as a conductive material were mixed together in a weight ratio of 97:2:1, and the mixture was distributed in N-methyl pyrrolidone to prepare a positive electrode active material slurry.

The positive electrode active material slurry was coated on an aluminum current collector of 14 μm in thickness, dried at 110° C., and then pressed to manufacture a positive electrode.

Artificial graphite and silicon nano-particles mixed together in a weight ratio of 93:7 as a negative electrode active material, styrene butadiene rubber (SBR) as a binder, and carboxymethyl cellulose (CMC) as a thickener were mixed together in a weight ratio of 97:1:2, and the mixture was distributed in distilled water to prepare a negative electrode active material slurry.

The negative electrode active material slurry was coated on a copper current collector of 10 μm in thickness, dried at 100° C., and then pressed to manufacture a negative electrode.

The positive electrode, the negative electrode, and a polyethylene separator of 25 μm in thickness were assembled to manufacture an electrode assembly, and the electrolyte was introduced to fabricate a rechargeable lithium battery.

### Example 2

An electrolyte and a rechargeable lithium battery were fabricated by the same method as that of Example 1, except that the additive included the first compound in an amount of 1 part by weight based on 100 parts by weight of the electrolyte and the second compound in an amount of 2 parts by weight based on 100 parts by weight of the electrolyte.

### Example 3

An electrolyte and a rechargeable lithium battery were fabricated by the same method as that of Example 1, except that the additive included the first compound in an amount of 1 part by weight based on 100 parts by weight of the electrolyte and the second compound in an amount of 3 parts by weight based on 100 parts by weight of the electrolyte.

### Example 4

An electrolyte and a rechargeable lithium battery were fabricated by the same method as that of Example 1, except that the additive included the first compound in an amount of 1 part by weight based on 100 parts by weight of the electrolyte and the second compound in an amount of 4 parts by weight based on 100 parts by weight of the electrolyte.

### Example 5

An electrolyte and a rechargeable lithium battery were fabricated by the same method as that of Example 1, except that the additive included the first compound in an amount of 1 part by weight based on 100 parts by weight of the electrolyte and the second compound in an amount of 5 parts by weight based on 100 parts by weight of the electrolyte.

### Comparative Example 1

An electrolyte and a rechargeable lithium battery were fabricated by the same method as that of Example 1, except that no additive was added.

### Comparative Example 2

An electrolyte and a rechargeable lithium battery were fabricated by the same method as that of Example 1, except that the additive included the first compound in an amount of 1 part by weight based on 100 parts by weight of the electrolyte and did not include the second compound.

### Comparative Example 3

An electrolyte and a rechargeable lithium battery were fabricated by the same method as that of Example 1, except that the additive did not include the first compound and included the second compound in an amount of 1 part by weight based on 100 parts by weight of the electrolyte.

### Comparative Example 4

An electrolyte and a rechargeable lithium battery were fabricated by the same method as that of Example 1, except that the additive included the first compound in an amount of 1 part by weight based on 100 parts by weight of the electrolyte and 1,2,3-triazole, instead of the second compound, in an amount of 1 part by weight based on 100 parts by weight of the electrolyte.

### Evaluation Example 1: Capacity Retention Rate at High-Temperature Storage

A high-temperature capacity retention rate was measured to evaluate high-temperature characteristics. Rechargeable lithium batteries fabricated according to the Examples and Comparative Examples were charged at room temperature (25° C.) to SOC 100% under the condition of constant current-constant voltage (CC/CV), 0.33 C, 4.25 V, and 0.025 C Cut-off, and then were stored at 55° C. for 90 days. Afterwards, a discharge capacity was measured to calculate a high-temperature capacity retention rate. The result was listed in Table 1 below. The high-temperature capacity retention rate was calculated according to Equation 1 below.

$$Equation 1$$

$$Capacity retention rate ( \% ) = ( discharge capacity after storage at 55 ° C . for \text{} 90 days / initial discharge capacity ) \times 100$$

### Evaluation Example 2: Resistance Increase Rate at High-Temperature Storage

Rechargeable lithium batteries fabricated according to the Examples and Comparative Examples were charged at room temperature (25° C.) to SOC 100% under the condition of constant current-constant voltage (CC/CV), 0.33 C, 4.25 V, and 0.025 C Cut-off, and then an initial battery resistance (DC-IR) and a battery resistance (DC-IR) after storage at 55° C. for 90 days were measured. A resistance increase rate was measured and the result was listed in Table 1 below. A resistance (DC-IR), which is calculated from a difference in current and voltage if different currents are applied, was obtained by using Ohm's law ΔR=ΔV/ΔI after being discharged at 1 C for 30 seconds in an initial full charge state. The resistance increase rate was calculated according to Equation 2 below.

$$Equation 2$$

$$Resistance increase rate ( \% ) = [ [ battery resistance \text{} ( DC - IR ) \text{} after 90 days / inital battery resistance ( DC - IR ) ] - 1 ] \times 100$$

### Evaluation Example 3: Gas Generation at High-Temperature Storage

Rechargeable lithium batteries fabricated according to the Examples and Comparative Examples were charged at 55° C. with 4.25 V, stored at 55° C. for 90 days, and then refinery gas analysis (RGA) was utilized to measure a gas generation amount (ml). The result was listed in Table 1 below.

TABLE 1

| | | | | | Evaluation Result | | | |
|---|---|---|---|---|---|---|---|---|
| | Amount | | | | Capacity | | Resistance | Gas |
| | First | Second | 1,2,3- | Initial | retention | Initial | increase | generation |
| | compound | compound | triazole | capacity | rate | resistance | rate | amount |
| | (wt %) | (wt %) | (wt %) | (mAh) | (%) | (mohm) | (%) | (ml) |
| Comparative | 0 | 0 | 0 | 5399 | 84.1 | 28.1 | 37 | 35.4 |
| Example 1 | | | | | | | | |
| Comparative | 1 | 0 | 0 | 5390 | 86.6 | 28.7 | 33.6 | 30.4 |
| Example 2 | | | | | | | | |
| Comparative | 0 | 1 | 0 | 5404 | 85.7 | 29.1 | 32.1 | 32.6 |
| Example 3 | | | | | | | | |
| Comparative | 1 | 0 | 1 | 5398 | 83.9 | 29.3 | 38.3 | 34.2 |
| Example 4 | | | | | | | | |
| Example 1 | 1 | 1 | 0 | 5389 | 86.3 | 29.2 | 28.5 | 24.5 |
| Example 2 | 1 | 2 | 0 | 5386 | 87.1 | 29.7 | 26 | 22.9 |
| Example 3 | 1 | 3 | 0 | 5380 | 87.5 | 30.1 | 25.5 | 22.1 |
| Example 4 | 1 | 4 | 0 | 5381 | 87.8 | 30.2 | 25.1 | 22.3 |
| Example 5 | 1 | 5 | 0 | 5381 | 88 | 30.1 | 25.4 | 21.5 |

Referring to Table 1, it may be ascertained that the capacity retention rate is similar or excellent at a high temperature (55° C.) in the cases (Examples 1 to 5) in which the electrolyte includes a first compound and a second compound according to embodiments of the present disclosure, compared to the case (Comparative Example 1) in which the electrolyte includes none of a first compound and a second compound, the case (Comparative Example 2) in which the electrolyte includes only a first compound, the case (Comparative Example 3) in which the electrolyte includes only a second compound, and the case (Comparative Example 4) in which the electrolyte includes a first compound and 1,2,3-triazole.

Referring to Table 1, it may be ascertained that the resistance increase rate is low at a high temperature (55° C.) in the cases (Examples 1 to 5) in which the electrolyte includes a first compound and a second compound according to embodiments of the present disclosure, compared to the case (Comparative Example 1) in which the electrolyte includes none of a first compound and a second compound, the case (Comparative Example 2) in which the electrolyte includes only a first compound, the case (Comparative Example 3) in which the electrolyte includes only a second compound, and the case (Comparative Example 4) in which the electrolyte includes a first compound and 1,2,3-triazole. For example, it may be ascertained that Examples 1 to 5 have an excellent effect of reduction in resistance.

Referring to Table 1, it may be ascertained that the gas generation amount is low at a high temperature (55° C.) in the cases (Examples 1 to 5) in which the electrolyte includes a first compound and a second compound according to embodiments of the present disclosure, compared to the case (Comparative Example 1) in which the electrolyte includes none of a first compound and a second compound, the case (Comparative Example 2) in which the electrolyte includes only a first compound, the case (Comparative Example 3) in which the electrolyte includes only a second compound, and the case (Comparative Example 4) in which the electrolyte includes a first compound and 1,2,3-triazole. For example, it may be ascertained that Examples 1 to 5 have an excellent effect of reduction in gas generation.

An electrolyte for a rechargeable lithium battery according to an embodiment may have effects of suppression or reduction in gas generation, improvement in capacity retention rate, and enhancement in lifetime characteristics of the rechargeable lithium battery. These effects may become pronounced at high temperatures.

While the subject matter of this disclosure has been described in connection with what is presently considered to be example embodiments, it is to be understood that the present disclosure is not limited to the disclosed embodiments and is intended to cover various modifications and equivalent arrangements included within the spirit and scope of the appended claims and equivalents thereof, and therefore the aforementioned embodiments should be understood to be examples but not limiting this disclosure in any way.

What is claimed is:

1. An electrolyte for a rechargeable lithium battery, the electrolyte comprising:
a non-aqueous organic solvent;
a lithium salt; and
an additive,
wherein the additive comprises a first compound represented by Chemical Formula 1 and a second compound represented by Chemical Formula 2, 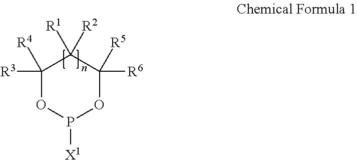
wherein, in Chemical Formula 1,
X¹ is a fluoro group, a chloro group, a bromo group, or an iodo group,
R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n is an integer of 0 or 1, 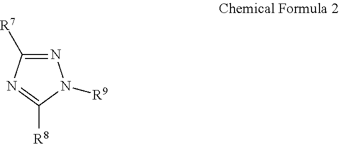
wherein, in Chemical Formula 2,
R⁷ to R⁹ are each independently hydrogen, halogen, a substituted or unsubstituted C1 to C10 alkyl group, or a substituted or unsubstituted C3 to C10 cycloalkyl group.

2. The electrolyte as claimed in claim 1, wherein an amount of the first compound is about 0.2 parts by weight to about 5.0 parts by weight based on 100 parts by weight of the electrolyte for the rechargeable lithium battery.

3. The electrolyte as claimed in claim 1, wherein an amount of the second compound is about 1 part by weight to about 5 parts by weight based on 100 parts by weight of the electrolyte for the rechargeable lithium battery.

4. The electrolyte as claimed in claim 1, wherein an amount of the additive is about 1.2 parts by weight to about 10 parts of weight based on 100 parts by weight of the electrolyte for the rechargeable lithium battery.

5. The electrolyte as claimed in claim 1, wherein a weight ratio of the second compound to the first compound in the additive is in a range of about 0.1 to about 25.

6. The electrolyte as claimed in claim 1, wherein a weight ratio of the second compound to the first compound in the additive is in a range of about 1 to about 5.

7. The electrolyte as claimed in claim 1, wherein Chemical Formula 1 is represented by Chemical Formula 1A or Chemical Formula 1B, 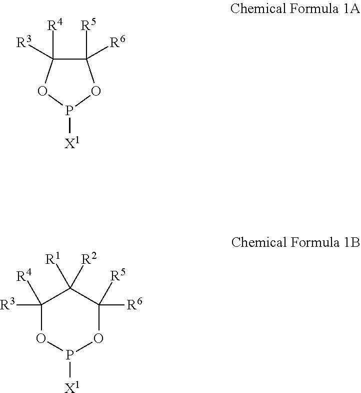
wherein, in Chemical Formula 1A and Chemical Formula 1B,
X¹ is a fluoro group, a chloro group, a bromo group, or an iodo group, and
R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

8. The electrolyte as claimed in claim 7, wherein:
R³ and R⁴ of Chemical Formula 1A are each hydrogen, and
at least one selected from R⁵ and R⁶ is a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

9. The electrolyte as claimed in claim 1, wherein the first compound is one selected from compounds listed in Group 1.

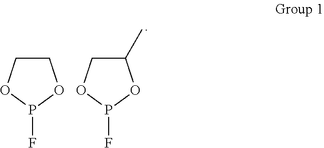

10. The electrolyte as claimed in claim 1, wherein the second compound is represented by Chemical Formula 2A.

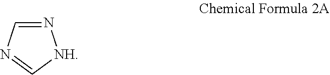

11. A rechargeable lithium battery, comprising:
a positive electrode comprising a positive electrode active material;
a negative electrode comprising a negative electrode active material; and
the electrolyte for the rechargeable lithium battery as claimed in claim 1.

12. The rechargeable lithium battery as claimed in claim 10, wherein the positive electrode active material comprises lithium composite oxide represented by Chemical Formula 3,
LiₓM¹_{y}M²_{z}M³_{1-y-z}O₂₋ₐXₐ Chemical Formula 3
wherein 0.5≤x≤1.8, 0≤a≤0.05, 0<y≤1, 0≤z≤1, and 0≤y+z≤1,
wherein M¹, M², and M³ each independently comprise at least one element selected from Ni, Co, Mn, Al, B, Ba, Ca, Ce, Cr, Fe, Mo, Nb, Si, Sr, Mg, Ti, V, W, Zr, La, and a combination thereof, and
wherein X comprises at least one element selected from F, S, P, and Cl.

13. The rechargeable lithium battery as claimed in claim 12, wherein, in Chemical Formula 3, M¹ is Ni, 0.8≤y≤1, and 0≤z≤0.2.

14. The rechargeable lithium battery as claimed in claim 11, wherein the negative electrode active material comprises a carbon-based negative electrode active material, a Si-based negative electrode active material, a Sn-based negative electrode active material, or a combination thereof.

15. The rechargeable lithium battery as claimed in claim 11, wherein the negative electrode active material comprises a carbon-based negative electrode active material and a Si-based negative electrode active material,
wherein the carbon-based negative electrode active material is graphite, and
wherein the Si-based negative electrode active material comprises a silicon nano-particle.
